(19) United States
(12) Patent Application Publication
(10) Pub. No.: US 2015/0081768 A1
(43) Pub. Date: Mar. 19, 2015

(54) SERVER, TERMINAL AND DATA PUSHING METHOD

(71) Applicants: Peking University Founder Group Co., Ltd., Beijing (CN); Founder Information Industry Group, Beijing (CN); Founder Apabi Technology Limited, Beijing (CN)

(72) Inventors: Xiang CHEN, Beijing (CN); Wei ZHENG, Beijing (CN)

(73) Assignees: Peking University Founder Group Co., Ltd., Beijing (CN); Founder Information Industry Group, Beijing (CN); Founder Apabi Technology Limited, Beijing (CN)

(21) Appl. No.: 14/103,091

(22) Filed: Dec. 11, 2013

(30) Foreign Application Priority Data
Sep. 16, 2013 (CN) 201310421389.2

(51) Int. Cl. H04L 29/08

(52) U.S. Cl. CPC H04L 67/26
USPC 709/203

(57) ABSTRACT

The present invention provides a server, a terminal and a data pushing method. The server comprises a request receiving unit configured to receive request information from at least one terminal and a pushing instruction from another server; a request generating unit configured to parsing the pushing instruction so as to obtain information of data associated with the terminal and generate a pushing request according to the information of the data associated with the terminal; and a request transmitting unit configured to transmit the pushing request to the terminal and transmit the request information to the other server, so that the other server determines the information of the data and generates the pushing instruction according to the request information.

### FIELD OF THE INVENTION

The present invention relates to a field of information technology, in particular to a server, a terminal and a data pushing method.

### DESCRIPTION OF THE PRIOR ART

Due to the rapid development of Mobile Internet, it becomes more convenient for the people to acquire information and more popular to use smart mobile terminals. The use of mobile devices to read news has become a part of the daily life for most of people.

News is an information carrier with a large data volume and strong timeliness. How to filter the news information effectively and in real time becomes a technical problem required to be solved when reading news using a mobile terminal. When there is a large amount of real-time news data, it is impossible to solve the above-mentioned technical problem in a traditional “data pulling” manner by a client. Currently, the best solution is to use a “server data pushing” technology.

Usually, according to the server data pushing technology, the client in the mobile terminal will periodically be connected to a server and inquire whether or not there are new contents required to updated. When using this solution, the client must communicate with the server, e.g., by using message queues, and at the same time needs to take a polling frequency into consideration. If the queues are polled too fast, it will lead to a lot of pressure on the server, and meanwhile lead to excessive consumption of the network traffic and battery power of the mobile device. If the queues are polled too slowly, the data cannot be updated in time.

Hence, there is no feasible solution in the related technologies capable of pushing the data from the server to the terminal.

### SUMMARY OF THE INVENTION

In order to solve at least one of the above problems, the present invention aims to provide a new data pushing solution, so as to enable an application server to specifically push data to a terminal, and meanwhile to relieve the service processing pressure on the server and improve the response speed of the server.

In one aspect, the present invention provides a server, comprising a request receiving unit configured to receive request information from at least one terminal and a pushing instruction from another server; a request generating unit configured to parsing the pushing instruction so as to obtain information of data associated with the terminal and generate a pushing request according to the information of the data associated with the terminal; and a request transmitting unit configured to transmit the pushing request to the terminal and transmit the request information to the other server, so that the other server determines the information of the data and generates the pushing instruction according to the request information.

A traditional application server (i.e., the other server of embodiments of the present invention) needs to, on one hand, establish connection with the terminal and receive the request information therefrom, and on the other hand, search data associated with the terminal according to the request information from the terminal and transmit the searched data to the terminal. If a connection is established between a plurality of terminals and the application server, the service processing pressure on the application server will be increased, the response speed of the server will be reduced, and it is unable to ensure a stable connection between the terminals and the application server. According to the present invention, the connection is merely established between the application server and a pushing server (i.e., the server of embodiments of the present invention), and the request information from the terminal is transmitted by the pushing server to the application server. As a result, it is able to process a part of the service of the application server (e.g., the service concerning the establishment and maintenance of a connection with a terminal) by the pushing server, thereby to reduce the service processing pressure on the application server and improve the respond speed of the application server. Meanwhile, the pushing server is responsible primarily for establishing the connection with the terminal, so it is able to ensure a stable connection between the terminal and the pushing server, and to increase the number of the terminals that will be connected with the pushing server.

In addition, if the application server directly transmits the data to be pushed to the terminal via the pushing server when the application server receives the request information transmitted by the pushing server from the terminal, on one hand, the pressure on the application server and the pushing server will be increased due to a large amount of data being transmitted between the pushing server and the application server, and on the other hand, the terminal cannot select whether or not to receive the data pushed by the application server and thereby the user experience will be decreased. For example, according to the related technologies, an intention of the server will be understood by intercepting an SMS message and parsing the message content, so as to fully perform the real-time operation. However, it is very difficult to find a gateway that transmits the SMS message for free, so the cost is relatively high. According to the present invention, the application server will transmit the information of the data to be pushed to the pushing server, so that the request processes between the application server and the plurality of terminals can be completely handled by the pushing server. As a result, it is able to handle the request processes of the application server in a unified manner, and to prevent the interaction cost when the terminals interact with the application server via different gateways. In addition, when the pushing server transmits the pushing request to the terminal, it is able to reduce the pressure on the data interaction between the application server and the pushing server. Meanwhile, the application server transmits the pushing request according to the request information from the terminals, so that the application server pushes the data specifically to the terminals, and as a result, the user experience will be improved.

In another aspect, the present invention further provides a terminal, comprising a request transmitting unit configured to transmit request information to a second server via a first server, so that the second sever determines information of data associated with the terminal and generate a pushing instruction according to the request information; a data receiving unit configured to receive a pushing request generated by the first server according to the pushing instruction; and a request parsing unit configured to parse the pushing request so as to obtain the information of the data associated with the terminal.

According to the present invention, the terminal transmits the request information to an application server (i.e., the second server of embodiments of the present invention) via a pushing server (i.e., the first server of embodiments of the present invention), so that the application server may determine the data to be pushed to the terminal according to the request information from the terminal. As a result, it is able to prevent the application server from aimlessly pushing the undesired data to the terminal, and thereby prevent any influences on the user experience. In addition, the information of the data associated with the terminal is pushed to the terminal, so that a user may determine whether or not to receive the corresponding data when the terminal receives the information of the data. As a result, it is able to prevent excessive consumption of the network traffic and battery power of the terminal when the application server is directly associated with the terminal but the undesired data is transmitted to the terminal.

In yet another aspect, the present invention further provides a data pushing system comprising the above-mentioned server and at least one of the above-mentioned terminals.

In yet another aspect, the present invention further provides a data pushing method, comprising: Step 402: when receiving request information from at least one terminal, transmitting, by a pushing server, the request information to an application server, so that the application server determines information of data associated with the terminal and generates a pushing instruction according to the request information; and Step 404: receiving, by the pushing server, the pushing instruction, parsing the pushing instruction so as to obtain the information of the data, generating a pushing request according to the information of the data, and transmitting the pushing request to the terminal.

A traditional application server needs to, on one hand, establish connection with the terminal and receive the request information therefrom, and on the other hand, search data associated with the terminal according to the request information from the terminal and transmit the searched data to the terminal. If a connection is established between a plurality of terminals and the application server, the service processing pressure on the application server will be increased, the response speed of the server will be reduced, and it is unable to ensure a stable connection between the terminals and the application server. According to the present invention, the connection is merely established between the application server and the pushing server, and the request information from the terminal is transmitted by the pushing server to the application server. As a result, it is able to process a part of the service of the application server (e.g., the service concerning the establishment and maintenance of a connection with a terminal) by the pushing server, thereby to reduce the service processing pressure on the application server and improve the respond speed of the application server. Meanwhile, the pushing server is responsible primarily for establishing the connection with the terminal, so it is able to ensure a stable connection between the terminal and the pushing server, and to increase the number of the terminals that will be connected with the pushing server.

In addition, if the application server directly transmits the data to be pushed to the terminal via the pushing server when the application server receives the request information transmitted by the pushing server from the terminal, on one hand, the pressure on the application server and the pushing server will be increased due to a large amount of data being transmitted between the pushing server and the application server, and on the other hand, the terminal cannot select whether or not to receive the data pushed by the application server and thereby the user experience will be decreased. For example, according to the related technologies, an intention of the server will be understood by intercepting an SMS message and parsing the message content, so as to fully perform the real-time operation. However, it is very difficult to find a gateway that transmits the SMS message for free, so the cost is relatively high. According to the present invention, the application server transmits the information of the data to be pushed to the pushing server, so that the request processes between the application server and the plurality of terminals can be completely handled by the pushing server. As a result, it is able to handle the request processes of the application server in a unified manner, and to prevent the interaction cost when the terminals interact with the application server via different gateways. In addition, when the pushing server transmits the pushing request to the terminal, it is able to reduce the pressure on the data interaction between the application server and the pushing server. Meanwhile, the application servers transmits the pushing request according to the request information from the terminals, so that the application server pushes the data specifically to the terminals, and as a result, the user experience will be improved.

In yet another aspect, the present invention further provides a data pushing method, comprising: Step 502: transmitting, by at least one terminal, request information to an application server via a pushing server, so that the application server determines information of data associated with the terminal and generates a pushing instruction according to the request information; Step 504: receiving, by the terminal, a pushing request generated by the pushing server according to the pushing instruction; and Step 506: parsing, by the terminal, the pushing request so as to obtain the information of the data associated with the terminal.

According to the present invention, the terminal transmits the request information to the application server via the pushing server, so that the application server may determine the data to be pushed to the terminal according to the request information from the terminal. As a result, it is able to prevent the application server from aimlessly pushing the undesired data to the terminal, and thereby prevent any influences on the user experience. In addition, the information of the data associated with the terminal is pushed to the terminal, so that a user may determine whether or not to receive the corresponding data when the terminal receives the information of the data. As a result, it is able to prevent excessive consumption of the network traffic and battery power of the terminal when the application server is directly associated with the terminal but the undesired data is transmitted to the terminal.

According to the present invention, it is able to enable the application server to specifically push the data to the terminal, and meanwhile to relieve the service processing pressure on the server and improve the response speed of the server.

### BRIEF DESCRIPTION OF THE DRAWINGS

FIG. 1 is a block diagram of a server according to embodiments of the present invention;

FIG. 2 is a block diagram of a terminal according to embodiments of the present invention;

FIG. 3 is a block diagram of a data pushing system according to embodiments of the present invention;

FIG. 4 is a flow chart of a data pushing method according to one embodiment of the present invention;

FIG. 5 is a flow chart of a data pushing method according to another embodiment of the present invention;

FIG. 6 is a flow chart of a data pushing method according to yet another embodiment of the present invention; and

FIG. 7 is a schematic view showing a data pushing system according to embodiments of the present invention.

### DETAILED DESCRIPTION OF THE PREFERRED EMBODIMENTS

In order to make the objects, the features and the advantages of the present invention more apparent, the present invention will be described hereinafter in conjunction with the drawings and the embodiments. It should be appreciated that, the embodiments and the features therein may be combined with each other if without confliction.

The details described hereinafter are used to facilitate the understanding of the present invention, but the present invention may further be implemented by the other ways different from those described hereinafter. Hence, the following embodiments are not used to limit the present invention.

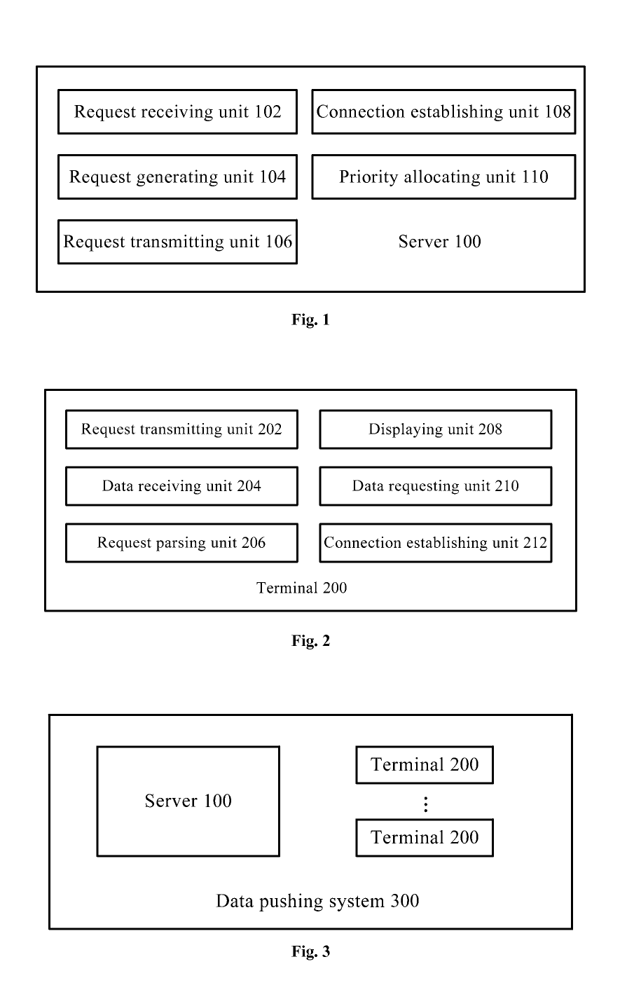

FIG. 1 is a block diagram of a server according to one embodiment of the present invention.

As shown in FIG. 1, the server 100 comprises a request receiving unit 102 configured to receive request information from at least one terminal and a pushing instruction from another server; a request generating unit 104 configured to parse the pushing instruction so as to obtain information of data associated with the terminal and generate a pushing request according to the information of the data associated with the terminal; and a request transmitting unit 106 configured to transmit the pushing request to the terminal and transmit the request information to the other server, so that the other server determines the information of the data and generates the pushing instruction according to the request information.

A traditional application server (i.e., the other server of embodiments of the present invention) needs to, on one hand, establish connection with the terminal and receive the request information therefrom, and on the other hand, search data associated with the terminal according to the request information from the terminal and transmit the searched data to the terminal. If a connection is established between a plurality of terminals and the application server, the service processing pressure on the application server will be increased, the response speed of the server will be reduced, and it is unable to ensure a stable connection between the terminals and the application server. According to the present invention, the connection is merely established between the application server and a pushing server (i.e., the server of embodiments of the present invention), and the request information from the terminal is transmitted by the pushing server to the application server. As a result, it is able to process a part of the service of the application server (e.g., the service concerning the establishment and maintenance of a connection with a terminal) by the pushing server, thereby to reduce the service processing pressure on the application server and improve the respond speed of the application server. Meanwhile, the pushing server is responsible primarily for establishing the connection with the terminal, so it is able to ensure a stable connection between the terminal and the pushing server, and to increase the number of the terminals that will be connected with the pushing server.

In addition, if the application server directly transmits the data to be pushed to the terminal via the pushing server when the application server receives the request information transmitted by the pushing server from the terminal, on one hand, the pressure on the application server and the pushing server will be increased due to a large amount of data being transmitted between the pushing server and the application server, and on the other hand, the terminal cannot select whether or not to receive the data pushed by the application server and thereby the user experience will be decreased. For example, according to the related technologies, an intention of the server will be understood by intercepting an SMS message and parsing the message content, so as to fully perform the real-time operation. However, it is very difficult to find a gateway that transmits the SMS message for free, so the cost is relatively high. According to the present invention, the application server transmits the information of the data to be pushed to the pushing server, so that the request processes between the application server and the plurality of terminals can be completely handled by the pushing server. As a result, it is able to handle the request processes of the application server in a unified manner, and to prevent the interaction cost when the terminals interact with the application server via different gateways. In addition, when the pushing server transmits the pushing request to the terminal, it is able to reduce the pressure on the data interaction between the application server and the pushing server. Meanwhile, the application server transmits the pushing request according to the request information from the terminals, so that the application server pushes the data specifically to the terminals, and as a result, the user experience will be improved.

Preferably, the request generating unit 104 is configured to parse the pushing instruction, so as to obtain address information and/or identification information of the data, and generate the pushing request according to the address information and/or identification information of the data.

The pushing server generates the pushing request according to the address information and/or identification information of the data and transmits the pushing request to the terminal, so that the terminal can download the corresponding data from the application server according to the address information and/or identification information of the data included in the pushing request when the terminal needs to receive the data pushed from the application server. In addition, because the instruction and/or request are transmitted between the application server and the pushing server, or between the pushing server and the terminal, it is able to reduce the data interactions between the application server and the pushing server, or between the pushing server and the terminal, thereby to optimize the performances of the application server and the pushing server, and improve the response speed thereof.

Preferably, the request generating unit 104 is further configured to parse the pushing instruction, so as to obtain identification information and/or position information of the terminal. The request transmitting unit is further configured to determine the terminal according to the identification information and/or position information of the terminal, so as to transmit the pushing request to the terminal.

The pushing server may transmit the request information from a plurality of terminals to the application server at the same time. The application server searches the data associated with the terminal according to the identification information and/or position information of the terminal, and then transmit the identification information and/or position information of the terminal, and the information of the data associated with the terminal to the pushing server. The pushing server parses the pushing instruction so as to obtain the identification information and/or position information of the terminal, and determine the information of the data associated with the terminal according to the identification information and/or position information of the terminal. As a result, it is able to prevent the data confusion caused when the information of the data associated with one of the terminals is transmitted to the other terminal, thereby to ensure that each terminal can receive the respective data information. In addition, because the respective data information is received by each terminal, it is able to prevent leakage of the data from the terminal, thereby to ensure the data security.

Preferably, the server further comprises a connection establishing unit 108 configured to establish a persistent connection with the terminal.

If the pushing server asks the terminal when it transmits the pushing request to the terminal every time (or if the terminal asks the pushing server when the pushing request needs to be pushed to the terminal by the pushing server), and establishes the connection and transmits the pushing request after the connection is confirmed, it will take a long waiting time to establish the connection every time. Hence, a persistent connection may be established between the terminal and the pushing server. When the pushing server needs to transmit the pushing request (or when the terminal transmits the request information to the pushing server), the pushing request may be directly transmitted via a persistent connection with the terminal, without asking the terminal and establishing a connection again. As a result, it is able to save the time for establishing the connection between the pushing server and the terminal. Of course, the persistent connection between the pushing server and the terminal may be broken when the pushing server has transmitted the pushing request to the terminal and there is no need to transmit the pushing request to the terminal within a period of time, so as to relieve the pressure on the pushing server, to facilitate the establishment of the persistent connection between the other terminal and the pushing server, thereby to prevent excessive consumption of the battery power of the mobile devices due to the persistent connection.

Preferably, the server further comprises a priority allocating unit 110 configured to set a connection state for each terminal, in an asynchronous non-blocking manner or via message queues, according to a priority of each of the at least one terminal, and allocate a priority for each connection according to the connection state. The connection establishing unit is configured to establish the persistent connection with each terminal according to the priority of each terminal.

If there are several terminals that are required to establish a connection with the pushing server at the same time, the connection may be unstable due to overload of the pushing server. Hence, through setting the priority of the connection state for each terminal, it is able to, when the pushing server is overloaded, break off the connection with the terminal with a low priority and/or reject a connection request from the terminal with a low priority, thereby to ensure a stable connection between the terminal with a high priority and the pushing server while reducing the load pressure on the pushing server.

FIG. 2 is a block diagram of a terminal according to embodiments of the present invention.

As shown in FIG. 2, the terminal 200 comprises a request transmitting unit 202 configured to transmit request information to a second server via a first server, so that the second sever determines information of data associated with the terminal 200 and generate a pushing instruction according to the request information; a data receiving unit 204 configured to receive a pushing request generated by the first server according to the pushing instruction; and a request parsing unit 206 configured to parse the pushing request so as to obtain the information of the data associated with the terminal 200.

According to the present invention, the terminal 200 transmits the request information to an application server (i.e., the second server of embodiments of the present invention) via a pushing server (i.e., the first server of embodiments of the present invention), so that the application server may determine the data to be pushed to the terminal 200 according to the request information from the terminal 200. As a result, it is able to prevent the application server from aimlessly pushing the undesired data to the terminal 200, and thereby prevent any influences on the user experience. In addition, the information of the data associated with the terminal 200 is pushed to the terminal 200, so that a user may determine whether or not to receive the corresponding data when the terminal 200 receives the information of the data. As a result, it is able to prevent excessive consumption of the network traffic and battery power of the terminal 200 when the application server is directly associated with the terminal 200 but the undesired data is transmitted to the terminal 200.

Preferably, the terminal 200 further comprises a display unit 208. The request parsing unit 206 is configured to parse the pushing request so as to obtain address information and/or identification information of the data, and the display unit 208 is configured to display the address information and/or identification information of the data.

The terminal 200 may display the address information and/or identification information of the data obtained after parsing the pushing request, so that the data information pushed by the application server to the terminal 200 can be visually displayed to the user. As a result, it is able to enable the user to select whether or not to receive the data pushed by the application server, thereby to improve the user experience.

Preferably, the terminal 200 further comprises a data requesting unit 210 configured to transmit a connection request to the application server according to the received connection instruction, so as to obtain the associated data.

If the user selects the data pushed by the application server after the terminal 200 parses the received pushing request, the terminal 200 may transmit the connection request to the application server, and download the data associated with the terminal 200 from the application server according to the parsed data information. Of course, after receiving and parsing the pushing request, the terminal 200 may directly transmit the connection request to the application server according to the parsed data information, so as to obtain the associated data.

Preferably, the terminal 200 further comprises a connection establishing unit 212 configured to establish a persistent connection with the first server.

If the pushing server asks the terminal 200 when it transmits the pushing request to the terminal 200 every time (or if the terminal 200 asks the pushing server when the pushing request needs to be pushed to the terminal 200 by the pushing server), and establishes the connection and transmits the pushing request after the connection is confirmed, it will take a long waiting time to establish the connection every time. Hence, a persistent connection may be established between the terminal 200 and the pushing server. When the pushing server needs to transmit the pushing request (or when the terminal 200 transmits the request information to the pushing server), the pushing request may be directly transmitted via the persistent connection with the terminal 200, without asking the terminal and establishing a connection again. As a result, it is able to save the time for establishing the connection between the pushing server and the terminal 200. Of course, the persistent connection between the pushing server and the terminal 200 may be broken when the pushing server has transmitted the pushing request to the terminal 200, so as to save the battery power of the terminal 200.

Preferably, the request information includes address information and/or position information of the terminal 200.

When the pushing server receives the address information and/or identification information of the terminal 200 and forwards the address information and/or identification information of the terminal 200 to the application server, the application server may determine the data associated with the terminal 200 according to the address information and/or identification information of the terminal 200. As a result, it is able to push the associated data to the terminal 200, thereby to prevent from affecting the user experience when the application server aimlessly pushes the data to the terminal 200.

FIG. 3 is a block diagram of a data pushing system according to an embodiment of the present invention.

As shown in FIG. 3, the data pushing system 300 comprises the server 100 as shown in FIG. 1 and at least one terminal 200 as shown in FIG. 2.

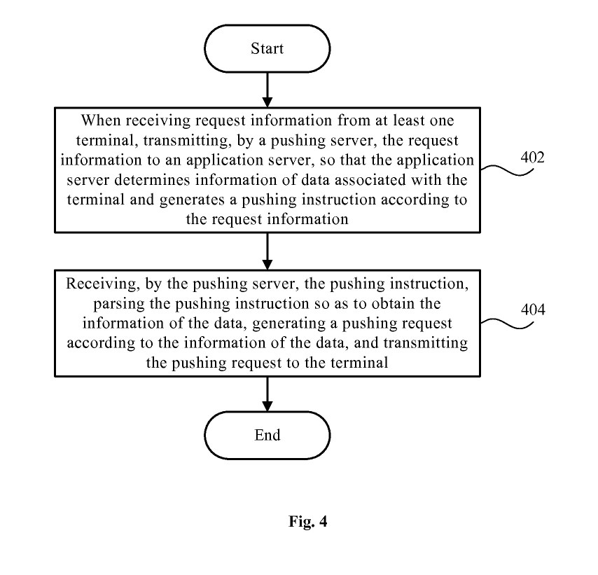

FIG. 4 is a flow chart of a data pushing method according to embodiments of the present invention.

As shown in FIG. 4, the data pushing method comprises: Step 402: when receiving request information from at least one terminal, transmitting, by a pushing server, the request information to an application server, so that the application server determines information of data associated with the terminal and generates a pushing instruction according to the request information; and Step 404: receiving, by the pushing server, the pushing instruction, parsing the pushing instruction so as to obtain the information of the data, generating a pushing request according to the information of the data, and transmitting the pushing request to the terminal.

A traditional application server needs to, on one hand, establish connection with the terminal and receive the request information therefrom, and on the other hand, search data associated with the terminal according to the request information from the terminal and transmit the searched data to the terminal. If a connection is established between a plurality of terminals and the application server, the service processing pressure on the application server will be increased, the response speed of the server will be reduced, and it is unable to ensure a stable connection between the terminals and the application server. According to the present invention, the connection is merely established between the application server and the pushing server, and the request information from the terminal is transmitted by the pushing server to the application server. As a result, it is able to process a part of the service of the application server (e.g., the service concerning the establishment and maintenance of a connection with a terminal) by the pushing server, thereby to reduce the service processing pressure on the application server and improve the respond speed of the application server. Meanwhile, the pushing server is responsible primarily for establishing the connection with the terminal, so it is able to ensure a stable connection between the terminal and the pushing server, and to increase the number of the terminals that will be connected with the pushing server.

In addition, if the application server directly transmits the data to be pushed to the terminal via the pushing server when the application server receives the request information transmitted by the pushing server from the terminal, on one hand, the pressure on the application server and the pushing server will be increased due to a large amount of data being transmitted between the pushing server and the application server, and on the other hand, the terminal cannot select whether or not to receive the data pushed by the application server and thereby the user experience will be decreased. For example, according to the related technologies, an intention of the server will be understood by intercepting an SMS message and parsing the message content, so as to fully perform the real-time operation. However, it is very difficult to find a gateway that transmits the SMS message for free, so the cost is relatively high. According to the present invention, the application server transmits the information of the data to be pushed to the pushing server, so that the request processes between the application server and the plurality of terminals can be completely handled by the pushing server. As a result, it is able to handle the request processes of the application server in a unified manner, and to prevent the interaction cost when the terminals interact with the application server via different gateways. In addition, when the pushing server transmits the pushing request to the terminal, it is able to reduce the pressure on the data interaction between the application server and the pushing server. Meanwhile, the application server transmits the pushing request according to the request information from the terminals, so that the application server pushes the data specifically to the terminals, and as a result, the user experience will be improved.

Preferably, Step 404 comprises: parsing, by the pushing server, the pushing instruction so as to obtain address information and/or identification information of data, and generating the pushing request according to the address information and/or identification information of the data.

The pushing server transmits the pushing request generated according to the address information and/or identification information of the data to the terminal, so that the terminal can download the corresponding data from the application server according to the address information and/or identification information of the data included in the pushing request when the terminal needs to receive the data pushed from the application server. In addition, because the instruction and/or request are transmitted between the application server and the pushing server, or between the pushing server and the terminal, it is able to reduce the data interactions between the application server and the pushing server, or between the pushing server and the terminal, thereby to optimize the performances of the application server and the pushing server, and improve the response speed thereof.

Preferably, Step 404 comprises: parsing, by the pushing server, the pushing instruction so as to obtain identification information and/or position information of the terminal, and determining the terminal according to the identification information and/or position information of the terminal so as to transmit the pushing request to the terminal.

The pushing server may transmit the request information from a plurality of terminals to the application server at the same time. The application server will search the data associated with the terminal according to the identification information and/or position information of the terminal, and then transmit the identification information and/or position information of the terminal, and the information of the data associated with the terminal to the pushing server. The pushing server parses the pushing instruction so as to obtain the identification information and/or position information of the terminal, and determine the information of the data associated with the terminal according to the identification information and/or position information of the terminal. As a result, it is able to prevent the data confusion caused when the information of the data associated with one of the terminals is transmitted to the other terminal, thereby to ensure that each terminal can receive the respective data information. In addition, because the respective data information is received by each terminal, it is able to prevent leakage of the data from the terminal, thereby to ensure the data security.

Preferably, prior to Step 402, the data pushing method further comprises establishing the persistent connection between the pushing server and the terminal.

If the pushing server asks the terminal when it transmits the pushing request to the terminal every time (or if the terminal asks the pushing server when the pushing request needs to be pushed to the terminal by the pushing server), and establishes the connection and transmits the pushing request after the connection is confirmed, it will take a long waiting time to establish the connection every time. Hence, the persistent connection may be established between the terminal and the pushing server. When the pushing server needs to transmit the pushing request (or when the terminal transmits the request information to the pushing server), the pushing request may be directly transmitted via the persistent connection with the terminal, without asking the terminal and establishing a connection again. As a result, it is able to save the time for establishing the connection between the pushing server and the terminal. Of course, the persistent connection between the pushing server and the terminal may be broken when the pushing server has transmitted the pushing request to the terminal and there is no need to transmit the pushing request to the terminal within a period of time, so as to relieve the pressure on the pushing server, to facilitate the establishment of the persistent connection between the other terminal and the pushing server, thereby to prevent excessive consumption of the battery power of the mobile devices due to the persistent connection.

Preferably, the pushing server may set a connection state for each terminal, in an asynchronous non-blocking manner or via message queues, according to a priority of each of the at least one terminal, and allocate a priority for each connection according to the connection state, so as to establish the persistent connection with each terminal according to the priority of each terminal.

If there are several terminals that are required to establish a connection with the pushing server at the same time, the connection may be unstable due to overload of the pushing server. Hence, through setting the priority of the connection state for each terminal, it is able to, when the pushing server is overloaded, break off the connection with the terminal with a low priority and/or reject a connection request from the terminal with a low priority, thereby to ensure a stable connection between the terminal with a high priority and the pushing server while reducing the load pressure on the pushing server.

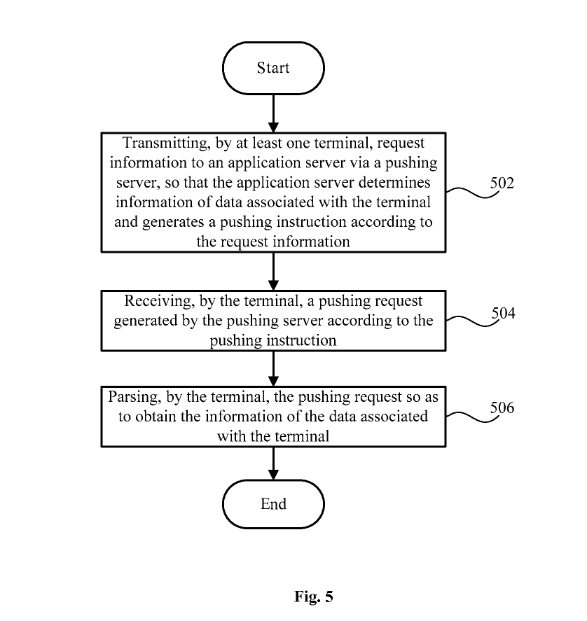

FIG. 5 is a flow chart of a data pushing method according to another embodiment of the present invention.

As shown in FIG. 5, the data pushing method comprises: Step 502: transmitting, by at least one terminal, request information to an application server via a pushing server, so that the application server determines information of data associated with the terminal and generates a pushing instruction according to the request information; Step 504: receiving, by the terminal, a pushing request generated by the pushing server according to the pushing instruction; and Step 506: parsing, by the terminal, the pushing request so as to obtain the information of the data associated with the terminal.

The terminal transmits the request information to the application server via the pushing server, so that the application server may determine the data to be pushed to the terminal according to the request information from the terminal. As a result, it is able to prevent the application server from aimlessly pushing the undesired data to the terminal, and thereby prevent any influences on the user experience. In addition, the information of the data associated with the terminal is pushed to the terminal, so that a user may determine whether or not to receive the corresponding data when the terminal receives the information of the data. As a result, it is able to prevent excessive consumption of the network traffic and battery power of the terminal when the application server is directly associated with the terminal but the undesired data is transmitted to the terminal.

Preferably, Step 506 comprises: parsing, by the terminal, the pushing request so as to obtain address information and/or identification information of the data, and displaying the address information and/or identification information of the data.

The terminal may display the address information and/or identification information of the data obtained after parsing the pushing request, so that the data information pushed by the application server to the terminal can be visually displayed to the user. As a result, it is able to enable the user to select whether or not to receive the data pushed by the application server, thereby to improve the user experience.

Preferably, the data pushing method further comprises: transmitting a connection request to the application server according to the received connection instruction, so as to obtain the associated data.

If the user selects the data pushed by the application server after the terminal parses the received pushing request, the terminal may transmit the connection request to the application server, and download the data associated with the terminal from the application server according to the parsed data information. Of course, after receiving and parsing the pushing request, the terminal may directly transmit the connection request to the application server according to the parsed data information, so as to obtain the associated data.

Preferably, the persistent connection is established between the terminal and the pushing server. After the terminal receives the pushing request, it will break off the persistent connection with the pushing server.

If the pushing server asks the terminal when it transmits the pushing request to the terminal every time (or if the terminal asks the pushing server when the pushing request needs to be pushed to the terminal by the pushing server), and establishes the connection and transmits the pushing request after the connection is confirmed, it will take a long waiting time to establish the connection every time. Hence, a persistent connection may be established between the terminal and the pushing server. When the pushing server needs to transmit the pushing request (or when the terminal transmits the request information to the pushing server), the pushing request may be directly transmitted via the persistent connection with the terminal, without asking the terminal and establishing a connection again. As a result, it is able to save the time for establishing the connection between the pushing server and the terminal. Of course, the persistent connection between the pushing server and the terminal may be broken when the pushing server has transmitted the pushing request to the terminal, so as to save the battery power of the terminal.

Preferably, the request information includes identification information and/or position information of the terminal.

When the pushing server receives the address information and/or identification information of the terminal and forwards the address information and/or identification information of the terminal to the application server, the application server may determine the data associated with the terminal according to the address information and/or identification information of the terminal. As a result, it is able to push the associated data to the terminal, thereby to prevent from affecting the user experience when the application server aimlessly pushes the data to the terminal.

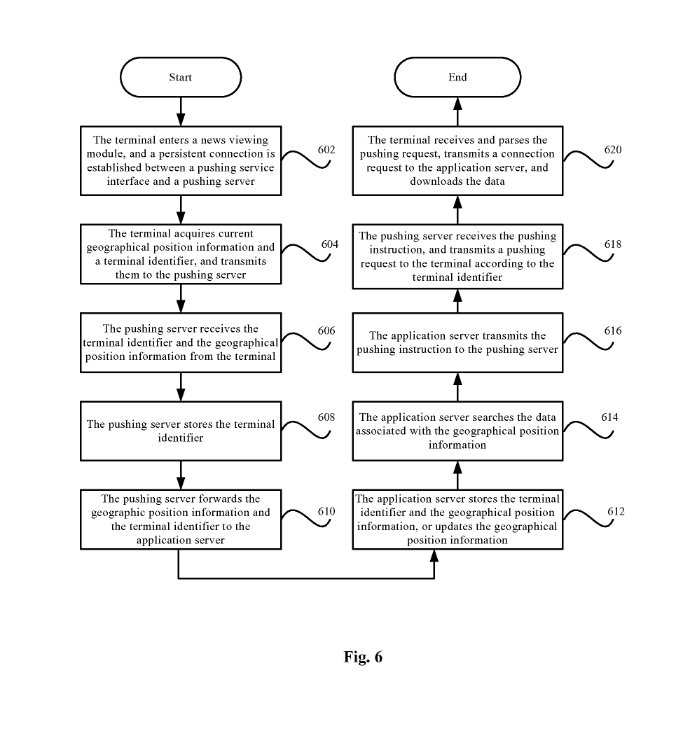

FIG. 6 is a flow chart of a data pushing method according to yet another embodiment of the present invention.

This embodiment is described hereinafter by taking a case where a server pushes news data associated with a geographical position to a terminal as an example. It should be appreciated that, the data pushed by the server includes but not limited to news data, and the data associated with the terminal includes but not limited to the data associated with the geographical position.

As shown in FIG. 6, the data pushing method comprises the following steps.

Step 602: the terminal enters a news viewing module, and a persistent connection is established between a pushing service interface, which is integrated in the terminal, and a pushing server. When the terminal enters the news viewing module, it corresponds to that the establishment of the persistent connection between the terminal and the pushing server is triggered. Of course, the establishment may be triggered by the other ways, e.g., by setting a connection state between the terminal and the pushing server. The pushing service interface is equivalent to a communication module of the terminal.

Step 604: the terminal acquires current geographical position information and a terminal identifier, and transmits them to the pushing server.

Step 606: the pushing server receives the terminal identifier and the geographical position information of the terminal from the terminal.

Step 608: the pushing server stores the terminal identifier, so that it can transmit the data associated with each terminal included in a pushing instruction to each terminal when receiving pushing instruction from the application server.

Step 610: the pushing server forwards the geographic position information and the terminal identifier to the application server, so that the application server searches the data associated with the geographical position information according to the geographical position information.

Step 612: the application server receives and stores the terminal identifier and the geographical position information, and updates the geographical position information corresponding to the terminal identifier if the terminal identifier exists. The application server may have stored the identification information of the terminal, and at this time it is merely required to update the geographical position information, and search the data associated with the geographical position information according to the up-to-date geographical position information.

Step 614: the application server searches the data associated with the geographical position information according to the geographical position information.

Step 616: the application server transmits the pushing instruction for pushing the searched data to the pushing server. The pushing instruction includes the terminal identification and the information of the data to be pushed.

Step 618: the pushing server receives the pushing instruction, parses the pushing instruction, and transmits a pushing request for the searched data to the terminal according to the parsed terminal identifier and the information of the corresponding searched data. The pushing server parses the terminal identifier and the data information associated with the terminal identifier, and transmits the data information associated with the terminal identifier to the corresponding terminal according to the terminal identifier. As a result, it is able to avoid data confusion.

Step 620: the terminal receives and parses the pushing request, transmits a connection request to the application server, and downloads the searched data. After the terminal parses the pushing request, a user may select whether or not to receive the data pushed by the application server. If yes, the terminal transmits the connection request to the application server, and if not the pushing request may be omitted.

The persistent connection is maintained between the terminal and the pushing server, and the application server is responsible for transmitting the pushing instruction to the pushing server so as to push the data to the terminal. As a result, it is able to reduce the possible load pressure due to the connection between the application server and the terminal, and to increase the response speed of the application server.

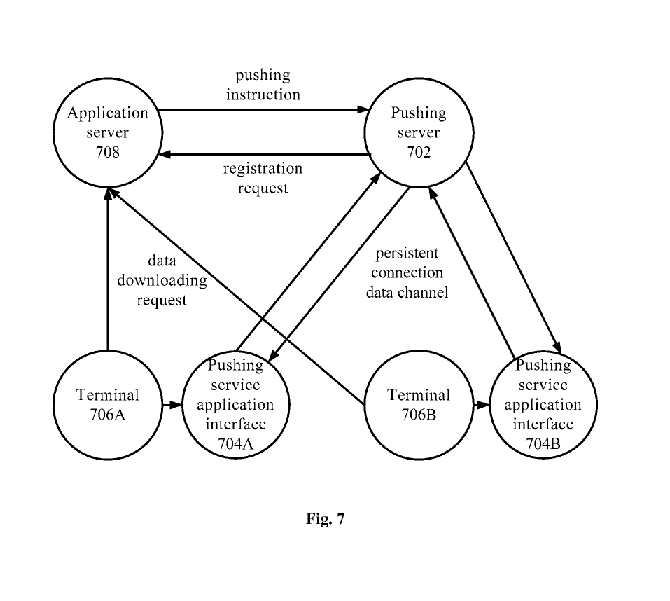

FIG. 7 is a schematic view showing a data pushing system according to embodiments of the present invention.

As shown in FIG. 7, the data pushing system comprises a pushing server 702, a pushing service application interface 704 (e.g., 704A and 704B as shown in FIG. 7), a terminal 706 and an application server 708.

In order to relieve the pressure on the application server 708 and improve the performance thereof, a separate server (i.e., the pushing server 702) is used to maintain the persistent connection with the terminal 706A and/or 706B. The pushing server 702 is merely responsible for maintain the persistent connection effectively and heavily, without involving any functions concerning the service. Meanwhile, the pushing server 702 is connected to the application server 708 so as to receive the instruction from the application server 708, and pushes the corresponding data to the pushing service application interface 704A and/or 704B, or forwards the data uploaded to the application server 708 via the pushing service application interface 704A and/or 704B. The pushing server 702 sets a connection state for each terminal in an asynchronous non-blocking manner, or sets a connection state for each terminal in a manner of message queues or priorities, and allocates the priority for different states, so as to ensure the persistence, stability and efficiency of the connection with the terminal 706A and/or 706B.

The pushing service application interface 704 is integrated in the terminal 706 (e.g., the pushing service application interface 704A is integrated in the terminal 706A and the pushing service application interface 704B is integrated in the terminal 706B as shown in FIG. 7). It is responsible for establishing and maintaining the persistent connection with the pushing server 702 in a high efficiency and low consumption manner. In the terminal 706, the pushing service application interface 704 individually creates a process, through which the persistent connection with the pushing server 702 is established when the establishment of the persistent connection between the terminal 706 and the pushing server 702 is triggered. By using the pushing service application interface 704, it is able to reduce the consumption of the network traffic and the battery power while maintaining the persistent connection. Meanwhile, the pushing service application interface 704 is also responsible for parsing the data pushed by the pushing server 702 and forwarding it to the terminal 706, and collecting the data from the terminal 706 and uploading it to the pushing server 702.

The terminal 706, into which the pushing service application interface 704 is integrated, is user-oriented, and may serve as to display the pushed data and collect the data to be uploaded to the application server 708. The terminal 706 receives and parses the data transmitted via the pushing service application interface 704, and the parsed data includes the information of the data to be pushed by the application server 708. After the data is parsed, the terminal 706 asks the user whether or not to receive the pushed data. If yes, the terminal 706 transmits a request to the application server 708 according to the parsed data, and acquires the real data to be pushed from the application server 708. By such a way, it is able to reduce the pressure on the pushing server 702 while avoiding the pushing server 702 from being directly involved in the service logic. Meanwhile, the data is pushed as the user likes, rather than forcibly.

The application server 708, as an initiator to push the data, is responsible for collecting and sorting the data, and then pushing the data to the pushing service application interface 704 via the pushing server 702. The application server 708 may sort the news data shared by the user on the terminal 706, and push the news data to a specified user according to the geographical position information. By filtering and sorting the data according to the geographical position information, it is able to search the data from a large volume of news data and push it to users within a region, thereby to reduce the difficulty in filtering the data by a local user while sharing the news. Meanwhile, the application server 708 needs to respond to the request initiated by the terminal 706, and transmit the associated news data to the terminal 706.

The data pushing system as shown in FIG. 7 has the following advantages.

(1) By using a separate server, it is able to reduce the pressure on the application server 708 and improve the performance thereof. By using a specific server (i.e., the pushing server 702) to maintain the persistent connection with the terminal 706, it is able to effectively increase the number of the terminals that enable the connection and to ensure a stable connection. The pushing server 702 allocates the connection state for each terminal so as to monitor the connection, thereby to support the effective connections and make full use of the hardware.

(2) By pushing the data via a server, a user may receive the up-to-date data in time, so the timeliness and validity of the data will be improved.

(3) By starting a separate process for the terminal 706, it is able to reduce the consumption of the network traffic and the battery power due to the persistent connection.

(4) With respect to the update frequency of the news, e.g., when the user opens a news application for the first time (or after a predetermined period of time), the server checks whether there is subscribed news information to be pushed according to the geographical position information and the identification information uploaded by the terminal 706. If yes, it pushes the data to the terminal, and if not, it breaks off the persistent connection so as to reduce the overhead of the server (of course, the persistent connection will not be broken off). A specific real-time news viewing module is provided in the terminal, and when the user opens the module, the persistent connection is established between the terminal and the pushing server 702, and the terminal waits for the data to be pushed. If the user exits the module, the pushing server 702 breaks off the persistent connection. By the above method, it is able to reduce some unnecessary persistent connections. If the user does not open the real-time news viewing module, the persistent connection will not be established, so there is no excessive pressure on the pushing server 702. When the user opens the real-time news viewing module, it is equivalent to triggering the establishment of the persistent connection between the terminal and the pushing server 702. Of course, the persistent connection may be established by the other ways, e.g., by setting the connection state for the terminal.

The present invention is described hereinabove in conjunction with the drawings. Considering that there is no feasible solution in the related technologies capable of pushing the data from the server to the terminal, the present invention provides the new data pushing solution, so as to enable the application server to specifically push data to the terminal, and meanwhile to relieve the service processing pressure on the server and improve the response speed of the server.

It should be appreciated that, the present invention may be provided as a method, a system or a computer program product, so the present invention may be in the form of full hardware embodiments, full software embodiments, or combinations thereof. In addition, the present invention may be in the form of a computer program product implemented on one or more computer-readable storage mediums (including but not limited to disk memory, CD-ROM and optical memory) including computer-readable program codes.

The present invention is described with reference to the flow charts and/or block diagrams showing the method, device (system) and computer program product according to the embodiments of the present invention. It should be appreciated that each process and/or block, or combinations thereof, in the flow charts and/or block diagrams may be implemented via computer program commands. These computer program commands may be applied to a general-purpose computer, a special-purpose computer, an embedded processor or any other processor of programmable data processing equipment, so as to form a machine, thereby to obtain the means capable of effecting the functions specified in one or more processes in the flow charts and/or one or more blocks in the block diagrams in accordance with the commands executed by the computer or the processor of the other programmable data processing equipment.

These computer program commands may also be stored in a computer-readable memory capable of guiding the computer or the other programmable data processing equipment to work in a special manner, so as to form a product including a command device capable of effecting the functions specified in one or more processes in the flow charts and/or one or more blocks in the block diagrams.

These computer program commands may also be loaded onto a computer or the other programmable data processing equipment, so as to perform a series of operations thereon and generate the processing implemented by the computer, thereby to provide the steps capable of effecting the functions specified one or more processes in the flow charts and/or one or more blocks in the block diagrams in accordance with the instructions.

The above are merely the preferred embodiments of the present invention, and these embodiments are not used to limit the present invention. It should be noted that, a person skilled in the art may further make improvements and modifications without departing from the spirit and principle of the present invention, and these improvements and modifications shall also be considered as the scope of the present invention.

What is claimed is:

1. A server, comprising:
a request receiving unit, configured to receive request information from at least one terminal and a pushing instruction from another server;
a request generating unit, configured to parsing the pushing instruction so as to obtain information of data associated with the terminal and generate a pushing request according to the information of the data associated with the terminal; and
a request transmitting unit, configured to transmit the pushing request to the terminal and transmit the request information to the other server, so that the other server determines the information of the data and generates the pushing instruction according to the request information.

2. The server according to claim 1, wherein the request generating unit is configured to parse the pushing instruction, so as to obtain address information and/or identification information of the data, and generate the pushing request according to the address information and/or identification information of the data.

3. The server according to claim 1, wherein the request generating unit is further configured to parse the pushing instruction, so as to obtain identification information and/or position information of the terminal, and the request transmitting unit is further configured to determine the terminal according to the identification information and/or position information of the terminal, so as to transmit the pushing request to the terminal.

4. The server according to claim 1, further comprising:
a connection establishing unit, configured to establish a persistent connection with the terminal.

5. The server according to claim 4, further comprising:
a priority allocating unit, configured to set a connection state for each terminal, in an asynchronous non-blocking manner or via message queues, according to a priority of each of the at least one terminal, and allocate a priority for each connection according to the connection state,
wherein the connection establishing unit is configured to establish the persistent connection with each terminal according to the priority of each terminal.

6. A terminal, comprising:
a request transmitting unit, configured to transmit request information to a second server via a first server, so that the second sever determines information of data associated with the terminal and generates a pushing instruction according to the request information;
a data receiving unit, configured to receive a pushing request generated by the first server according to the pushing instruction; and
a request parsing unit, configured to parse the pushing request so as to obtain the information of the data associated with the terminal.

7. The terminal according to claim 6, further comprising a display unit,
wherein the request parsing unit is configured to parse the pushing request so as to obtain address information and/or identification information of the data, and the display unit is configured to display the address information and/or identification information of the data.

8. The terminal according to claim 6, further comprising:
a data requesting unit, configured to transmit a connection request to the application server according to a received connection instruction, so as to obtain the associated data.

9. The terminal according to claim 6, further comprising:
a connection establishing unit, configured to establish a persistent connection with the first server.

10. The terminal according to claim 6, wherein the request information includes address information and/or position information of the terminal.

11. A data pushing method, comprising:
Step 402: when receiving request information from at least one terminal, transmitting, by a pushing server, the request information to an application server, so that the application server determines information of data associated with the terminal and generates a pushing instruction according to the request information; and
Step 404: receiving, by the pushing server, the pushing instruction, parsing the pushing instruction so as to obtain the information of the data, generating a pushing request according to the information of the data, and transmitting the pushing request to the terminal.

12. The data pushing method according to claim 11, wherein Step 404 comprises: parsing, by the pushing server, the pushing instruction so as to obtain address information and/or identification information of data, and generating the pushing request according to the address information and/or identification information of the data.

13. The data pushing method according to claim 11, wherein Step 404 comprises: parsing, by the pushing server, the pushing instruction so as to obtain identification information and/or position information of the terminal, and determining the terminal according to the identification information and/or position information of the terminal so as to transmit the pushing request to the terminal.

14. The data pushing method according to claim 11, wherein prior to Step 402, the data pushing method further comprises:
establishing a persistent connection between the pushing server and the terminal.

15. The data pushing method according to claim 14, wherein the pushing server sets a connection state for each terminal, in an asynchronous non-blocking manner or via message queues, according to a priority of each of the at least one terminal, and allocates a priority for each connection according to the connection state, so as to establish the persistent connection with each terminal according to the priority of each terminal.

16. A data pushing method, comprising:
Step 502: transmitting, by at least one terminal, request information to an application server via a pushing server, so that the application server determines information of data associated with the terminal and generates a pushing instruction according to the request information;
Step 504: receiving, by the terminal, a pushing request generated by the pushing server according to the pushing instruction; and
Step 506: parsing, by the terminal, the pushing request so as to obtain the information of the data associated with the terminal.

17. The data pushing method according to claim 16, wherein Step 506 comprises: parsing, by the terminal, the pushing request so as to obtain address information and/or identification information of the data, and displaying the address information and/or identification information of the data.

18. The data pushing method according to claim 16, further comprising:
transmitting a connection request to the application server according to a received connection instruction, so as to obtain the associated data.

19. The data pushing method according to claim 16, wherein a persistent connection is established between the terminal and the pushing server, and after the terminal receives the pushing request, the terminal breaks off the persistent connection with the pushing server.

20. The data pushing method according to claim 16, wherein the request information includes identification information and/or position information of the terminal.
